(19) United States
(12) Patent Application Publication
(10) Pub. No.: US 2024/0381188 A1
(43) Pub. Date: Nov. 14, 2024

(54) ROAMING BETWEEN GENERATIONS ACCESS POINTS UTILIZES DIFFERENT SECURITY PROTOCOLS

(71) Applicant: Cisco Technology, Inc., San Jose, CA (US)

(72) Inventors: Stephen M Orr, Wallkill, NY (US); Indermeet Singh Gandhi, San Jose, CA (US); Malcolm Muir Smith, Richardson, TX (US)

(21) Appl. No.: 18/356,962

(22) Filed: Jul. 21, 2023

Related U.S. Application Data
(60) Provisional application No. 63/501,842, filed on May 12, 2023.

(51) Int. Cl. H04W 36/00; H04W 12/041

(52) U.S. Cl. CPC H04W 36/0038; H04W 12/041; H04W 84/12

(57) ABSTRACT

The present technology provides for efficient re-association of a STA from a first Wi-Fi AP to a second Wi-Fi AP where the respective Wi-Fi APs utilize different security protocols. Since the association and key management (AKM) protocols are different and the cipher suites between generations of Wi-Fi technology, a STA normally would not be able to take advantage of the fast transition process. However, since the present technology allows the STA to derive the security keys in advance, the STA can perform the fast transition and efficiently roam to the Wi-Fi AP that utilizes a different association and key management (AKM) version.

### CROSS-REFERENCE TO RELATED APPLICATIONS

This application claims priority to U.S. provisional application No. 63/501,842, filed on May 12, 2023, which is expressly incorporated by reference herein in its entirety.

### BACKGROUND

Wi-Fi technology has undergone continuous evolution and innovation since its inception, resulting in significant advancements with each new generation. Following Wi-Fi 5 (802.11ac) there has been Wi-Fi 6 (802.11ax), Wi-Fi 7 (802.11 be), and soon there will be Wi-Fi 8 and Wi-Fi 9 (802.11ce), each iteration brings notable improvements in speed, capacity, efficiency, and overall performance.

Wi-Fi 5 introduced substantial upgrades over its predecessor, Wi-Fi 4 (802.11n). It introduced the use of wider channel bandwidths, multi-user MIMO (Multiple-Input Multiple-Output), and beamforming technologies. These advancements significantly increased data transfer rates and improved network capacity, allowing multiple devices to simultaneously connect and communicate more efficiently. Wi-Fi 6 included enhanced orthogonal frequency-division multiple access (OFDMA) and target wake time (TWT) mechanisms and included greater frequency, and improved overall spectral efficiency and power management and better performance in crowded areas. Wi-Fi 7 (802.11be) delivers speeds of up to 30 Gbps, utilizing multi-band operation, advanced MIMO techniques, and improved modulation schemes. Wi-Fi 7 also focuses on reducing latency and enhancing security features.

Wi-Fi 8 (802.11 ce) aims to revolutionize wireless connectivity by pushing data rates to new heights, reaching up to 100 Gbps. It is expected to introduce advancements like terahertz frequencies, enhanced spatial reuse, and advanced beamforming techniques, paving the way for futuristic applications and seamless connectivity experiences.

As Wi-Fi technology continues to evolve, each new generation brings improvements that address the growing demands of modern networks, including increased device density, higher data rates, lower latency, and better overall network performance. These advancements play a crucial role in enabling emerging technologies, supporting the proliferation of smart devices, and transforming the way we connect and communicate in an increasingly interconnected world.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a block diagram of an example wireless communication network according to some aspects of the present technology.

FIG. 2A is a network diagram illustrating an example network environment of multi-link operation, according to some aspects of the present technology.

FIG. 2B depicts an illustrative schematic diagram for multi-link operation between two logical entities, in accordance with one or more example embodiments of the present technology.

FIG. 2C depicts an illustrative schematic diagram for multi-link operation between APs with logical entities and a non-AP with logical entities, according to some aspects of the present technology.

FIG. 3 illustrates an example routine for facilitating a fast transition for a STA roaming from a first Wi-Fi AP to a second Wi-Fi AP where the Wi-Fi APs utilize different security protocols in accordance with some aspects of the present technology.

FIG. 4A and FIG. 4B illustrates a STA roaming from a Wi-Fi AP using WPA-2 to a Wi-Fi AP using WPA-3 in accordance with some aspects of the present technology.

FIG. 5A and FIG. 5B, which illustrates STA is roaming from a Wi-Fi AP using WPA-3 to a Wi-Fi AP using WPA-2 in accordance with some aspects of the present technology.

FIG. 6 shows an example of a system for implementing certain aspects of the present technology.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### OVERVIEW

### Abbreviations—

Extremely high throughput (EHT)
Station (STA)
Robust Security Network Element (RSNE)
Association and key management (AKM)
Pairwise Master Key (PMK)
Pairwise Transient Key (PTK)
Basic service set (BSS)
Access Point (AP)
Wireless LAN Controller (WLC)
Wi-Fi Protected Access (WPA)
MLD: Multi-Link Device
MLO: Multi-link operation
Extended Service Set (ESS)
Service Set Identifier (SSID)
Wireless Local Area Network (WLAN)
Advanced Encryption Standard (AES)
Fast Transition (FT)

In some aspects, the present technology includes communicating, by an STA, with a first Wi-Fi AP with messages secured utilizing a first security protocol. The STA can request candidate Wi-Fi APs in which to connect as the STA roams. The STA can receive an identification of a second Wi-Fi AP utilizing a second security protocol, where the second security protocol is different than the first security protocol, and can re-associate to the second Wi-Fi AP using a fast transition using aspects of the second security protocol.

The present technology may also include further include informing entities within a Wi-Fi network that the STA requires roaming support that includes support for WPA-2 and WPA-3 security protocols in an association request message.

The present technology may also include further include, prior to a handshake with the first Wi-Fi AP, sharing information about security protocols supported by the STA within a Wi-Fi network, and establishing a connection with the first Wi-Fi AP.

The present technology may also include where the first security protocol includes a first AKM version and a first cipher suite and the second security protocol utilizes a second AKM version and a second cipher suite.

The present technology may also include further includes prior to the re-associating to the second Wi-Fi AP, deriving keys to associate with the second Wi-Fi AP using a second AKM version.

The present technology may also include further includes determining to transition to the second Wi-Fi AP, communicating with the first Wi-Fi AP in a BSS Transition response informing the first Wi-Fi AP that the STA is going to transition to the second Wi-Fi AP.

The present technology may also include further includes receiving an action frame specifying the second Wi-Fi AP as a target to which to transition.

The present technology may also include where the receiving the identification of the second Wi-Fi AP utilizing the second security protocol includes receiving a plurality of Wi-Fi APs including the second Wi-Fi AP.

Other technical features may be readily apparent to one skilled in the art from the following figures, descriptions, and claims.

### Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for efficient re-association of an STA from an AP using Wi-Fi 7/8 technology and associated MKA versions and cipher suites to an AP using Wi-Fi 5/6 technology and associated MKA versions and cipher suites. The efficient re-association of the STA to a new AP that uses different keys and key exchange mechanisms can be facilitated without requiring the initiation of a key exchange protocol from the beginning when roaming between the APs. The disclosed technology also works in the inverse direction such as when roaming from an AP using Wi-Fi 5/6 technology and associated MKA versions and cipher suites to an AP using Wi-Fi 7/8 technology and associated MKA versions and cipher suites.

Most customers choose to incorporate new generations of access points (APs) into their existing infrastructure instead of completely replacing it. This trend will likely continue with the introduction of Wi-Fi 7 and 8, which will coexist with older generations of APs. However, one significant difference between EHT AP/EHT+AP (Wi-Fi 7/8) and legacy APs (Wi-Fi 5/6) is the mandatory support of WPA-3 in Wi-Fi 7/8 APs. The WPA3 spec states that the STA prefers a “new” AKM over legacy AKMs, when both are advertised on Wi-Fi 7/8 AP. Legacy AKMs should never get negotiated when two Wi-Fi 7 devices associate. In other words, when a Wi-Fi 7/8AP advertises, the AKM Suite List and Pairwise Cipher Suite List fields will carry legacy AKMs/ciphers (in addition to “new” AKMs/ciphers) to support association by legacy (pre-Wi-Fi 7) STAs. As legacy AKMs are invalid for Wi-Fi 7/8 associations, a Wi-Fi 7/8 STA will use a new AKM when associating with Wi-Fi 7/8 AP and will use legacy AKMs/ciphers when associating with legacy (pre-Wi-Fi 7) APs. This will break roaming between Wi-Fi 7/8 APs and legacy APs as their advertised AKM and cipher suite will differ. As a result, a Wi-Fi 7/8 STA will need to establish a new association with Wi-Fi 7/8 APs and will be unable to achieve seamless roaming.

In enterprise environments this issue is pronounced since the selection of AKM suites is not performed on an AP-by-AP basis per SSID/WLAN (e.g., to handle boundary conditions). Instead, the selection of AKM suites is based on an expanded service set (ESS), which are a set of commonly managed APs. A significant problem caused by the AKM issue above is the loss of fast transitions as STAs roam from AP to AP since the STA will disassociate invalidating the MAC state including the 802.1X state such as the AKM/ciphers, etc. The STA would then need to (freshly) associate with the new AP, establishing new MAC/802.1X state which may require lengthy network delays (e.g., re-keying, AAA/RADIUS interaction). The present technology addresses these problems by facilitating seamless roaming between non-EHT APs (Wi-Fi 5/6) and EHT/EHT++ APs (Wi-Fi 7/8).

A used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

Aspects of the present disclosure can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IoT) network.

IEEE 802.11, commonly referred to as Wi-Fi, has been around for three decades and has become arguably one of the most popular wireless communication standards, with billions of devices supporting more than half of the worldwide wireless traffic. The increasing user demands in terms of throughput, capacity, latency, spectrum and power efficiency calls for updates or amendments to the standard to keep up with them. As such, Wi-Fi generally has a new amendment after every few years with its own characteristic features. In the earlier generations, the focus was primarily higher data rates, but with ever increasing density of devices, area efficiency has become a major concern for Wi-Fi networks. Due to this issue, the last (802.11 be (Wi-Fi 7)) amendments focused more on efficiency though higher data rates were also included. The next expected update to IEEE 802.11 is coined as Wi-Fi 8. Wi-Fi 8 will attempt to further enhance throughput and minimize latency to meet the ever growing demand for the Internet of Things (IoT), high resolution video streaming, low-latency wireless services, etc.

Multiple Access Point (AP) coordination and transmission in Wi-Fi refers to the management of multiple access points in a wireless network to avoid interference and ensure efficient communication between the client devices and the network. When multiple access points are deployed in a network—for instance in buildings and office complexes—they operate on the same radio frequency, which can cause interference and degrade the network performance. To mitigate this issue, access points can be configured to coordinate their transmissions and avoid overlapping channels.

Wi-Fi 7 introduced the concept of multi-link operation (MLO), which gives the devices (Access Points (APs) and Stations (STAs)) the capability to operate on multiple links (or even bands) at the same time. MLO introduces a new paradigm to multi-AP coordination which was not part of the earlier coordination approaches. MLO is considered in Wi-Fi-7 to improve the throughput of the network and address the latency issues by allowing devices to use multiple links.

A multi-link device (MLD) may have several “affiliated” devices, each affiliated device having a separate PHY interface, and the MLD having a single link to the Logical Link Control (LLC) layer. In IEEE 802.11be, a multi-link device (MLD) is defined as: “A device that is a logical entity and has more than one affiliated station (STA) and has a single medium access control (MAC) service access point (SAP) to logical link control (LLC), which includes one MAC data service” (see: LAN/MAN Standards Committee of the IEEE Computer Society, Amendment 8: Enhancements for extremely high throughput (EHT), IEEE P802.11 be™/D0.1, September 2020, section 3.2). Connection(s) with an MLD on the affiliated devices may occur independently or jointly. A preliminary definition and scope of a multi-link element is described in section 9.4.2.247b of aforementioned IEEE 802.11 be draft. An idea behind this information element/container is to provide a way for multi-link devices (MLDs) to share the capabilities of different links with each other and facilitate the discovery and association processes. However, this information element may still be changed or new mechanisms may be introduced to share the MLO information (e.g. related to backhaul usage).

In multi-link operation (MLO) both STA and APs can possess multiple links that can be simultaneously active. These links may or may not use the same bands/channels.

MLO allows sending PHY protocol data units (PPDUs) on more than one link between a STA and an AP. The links may be carried on different channels, which may be in different frequency bands. Based on the frequency band and/or channel separation and filter performance, there may be restrictions on the way the PPDUs are sent on each of the links.

MLO may include a basic transmission mode, an asynchronous transmission mode, and a synchronous transmission mode.

In a basic transmission mode, there may be multiple primary links, but a device may transmit PPDU on one link at a time. The link for transmission may be selected as follows. The device (such as an AP or a STA) may count down a random back off (RBO) on both links and select a link that wins the medium for transmission. The other link may be blocked by in-device interference. In basic transmission mode, aggregation gains may not be achieved.

In an asynchronous transmission mode, a device may count down the RBO on both links and perform PPDU transmission independently on each link. The asynchronous transmission mode may be used when the device can support simultaneous transmission and reception with bands that have sufficient frequency separation such as separation between the 2.4 GHz band and the 5 GHz band. The asynchronous transmission mode may provide both latency and aggregation gains.

In a synchronous PPDU transmission mode, the device may count down the RBO on both links. If a first link wins the medium, both links may transmit PPDUs at the same time. The transmission at the same time may minimize in-device interference and may provide both latency and aggregation gains.

Multi-AP coordination and MLO are two features proposed to improve the performance of Wi-Fi networks in the upcoming IEEE 802.11 be amendment. Multi-AP coordination is directed toward utilizing (distributed) coordination between different APs to reduce inter-Basic Service Set (BSS) interference for improved spectrum utilization in dense deployments. MLO, on the other hand, supports high data rates and low latency by leveraging flexible resource utilization offered by the use of multiple links for the same device.

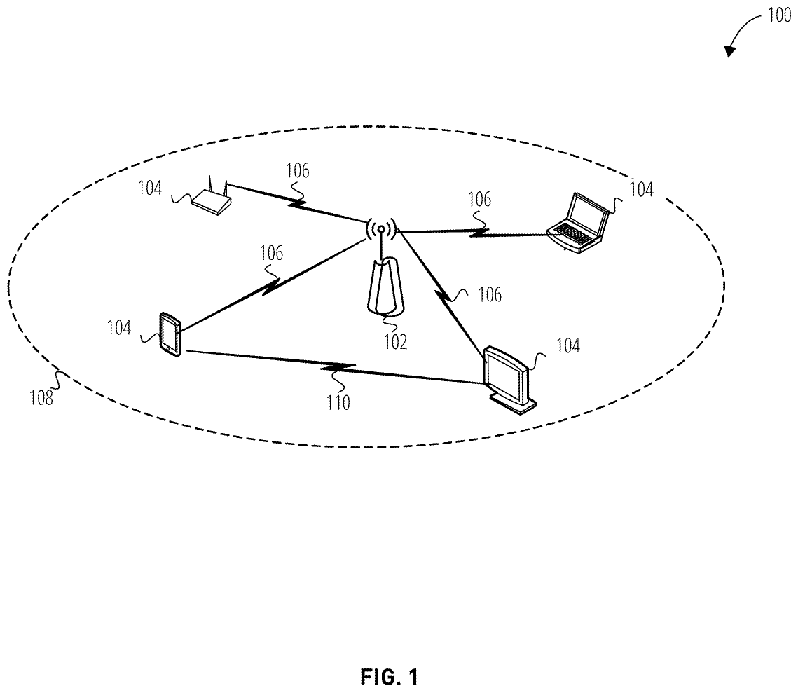

FIG. 1 illustrates a block diagram of an example wireless communication network according to some aspects of the present technology. Wireless communication network 100 can be an example of a wireless local area network (WLAN) such as a Wi-Fi network (and will hereinafter be referred to as WLAN 100). For example, WLAN 100 can be a Wi-Fi network operating based on any currently available or to be developed IEEE 802.11 protocols and standards (e.g., 802.11 ay, 802.11 ax, 802.11az, 802.11ba and 802.11 be, 802.11ce etc.). WLAN 100 may include wireless communication devices such as an AP 102 and multiple STAs 104. The number of APs and STAs are not limited to that shown in FIG. 1 and can be more or less. Any one or more of AP 102 and STAs 104 may be capable of MLO (multi-link reception and/or transmission).

Each of STAs 104 can be any one or more of mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), IoT devices, etc.

A single AP 102 and an associated set of STAs 104 may be referred to as a basic service set (BSS), managed by AP 102.

FIG. 1 shows an example coverage area 108 of AP 102, which may represent a basic service area (BSA) of WLAN 100. BSS may be identified to users by a service set identifier (SSID), as well as to other devices by a basic service set identifier (BSSID), which may be a medium access control (MAC) address of AP 102. AP 102 can periodically broadcast beacons including BSSID to enable any STA 104 within wireless range of AP 102 to “associate” or re-associate with AP 102 to establish a communication link 106 with AP 102. For example, the beacons can include an identification of a primary channel used by respective AP 102 as well as a timing synchronization function for establishing or maintaining timing synchronization with AP 102.

To establish a communication link 106 with an AP 102, each of STAs 104 is configured to perform passive or active scans on frequency channels in one or more frequency bands (for example, the 2.4 GHz, 5 GHz, 6 GHz or 60 GHz bands). Passive scans entail an STA 104 listening for beacons transmitted by AP 102 at a periodic time interval referred to as the target beacon transmission time (TBTT) (measured in time units (TUs) where one TU may be equal to 1024 microseconds (s)). Active scans entail an STA 104 generating and sequentially transmitting probe requests on each channel to be scanned and listens for probe responses from APs 102. Each STA 104 may be configured to identify or select an AP 102 with which to associate based on the scanning information obtained through the passive or active scans, and to perform authentication and association operations to establish a communication link 106 with a selected AP 102. AP 102 assigns an association identifier to STA 104 at the conclusion of the association operations, which AP 102 can then utilize to track STA 104.

As a result of the increasing ubiquity of wireless networks, an STA 104 may have the opportunity to select one of many APs 102 within range of the STA or to select among multiple APs 102 that together form an extended service set (ESS) including multiple connected APs 102. An extended network station associated with WLAN 100 may be connected to a wired or wireless distribution system that may allow multiple APs 102 to be connected in such an ESS. As such, an STA 104 can be covered by more than one AP 102 and can associate with different APs 102 at different times for different transmissions. Additionally, after association with an AP 102, an STA 104 also may be configured to periodically scan its surroundings to find a more suitable AP 102 with which to associate. For example, an STA 104 that is moving relative to its associated AP 102 may perform a roaming scan to find another AP 102 having more desirable network characteristics such as a greater received signal strength indicator (RSSI), a reduced traffic load, etc.

In some cases, STAs 104 may form ad-hoc networks without APs 102. In some examples, ad hoc networks may be implemented within a larger wireless network such as WLAN 100. In such implementations, while the STAs 104 may be capable of communicating with each other through the AP 102 using communication links 106, STAs 104 also can communicate directly with each other via direct wireless links 110. Additionally, two STAs 104 may communicate via a direct communication direct wireless link 110 regardless of whether both STAs 104 are associated with and served by same AP 102. In such an ad hoc system, one or more of STAs 104 may assume the role filled by AP 102 in a BSS. Such an STA 104 may coordinate transmissions within the ad hoc network. Examples of direct wireless links 110 include Wi-Fi Direct connections, connections established by using a Wi-Fi Tunneled Direct Link Setup (TDLS) link, and/or any other known or to be developed direct wireless communication scheme.

APs 102 and STAs 104 may function and communicate (via the respective communication links 106) according to the IEEE 802.11 family of wireless communication protocol standards. AP 102 and STAs 104 in WLAN 100 may transmit PPDUs over an unlicensed spectrum that can include frequency bands used by Wi-Fi technology, such as the 2.4 GHz band, the 5 GHz band, the 60 GHz band, the 3.6 GHz band, and the 900 MHz band. Some implementations of AP 102 and STAs 104 described herein also may communicate in other frequency bands, such as the 6 GHz band, which may support both licensed and unlicensed communications. AP 102 and STAs 104 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11 be standard amendments may be transmitted over the 2.4, 5 GHz, or 6 GHz bands, each of which can be divided into multiple 20 MHz channels. PPDUs can be transmitted over a physical channel having a minimum bandwidth of 20 MHz or larger channels having bandwidths of 40 MHz, 80 MHz, 160 or 320 MHz, etc., which can be formed by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

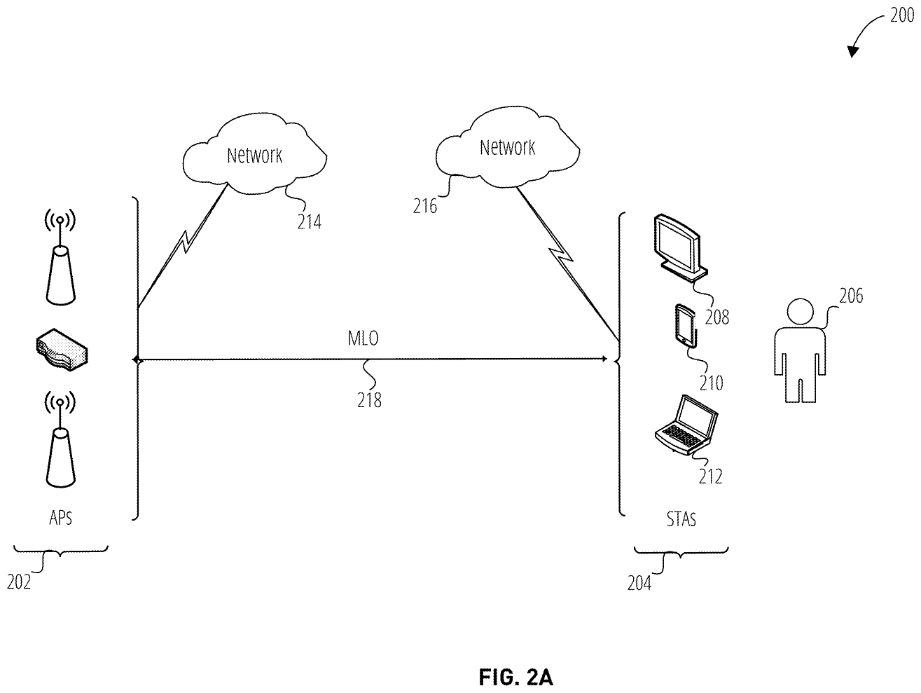

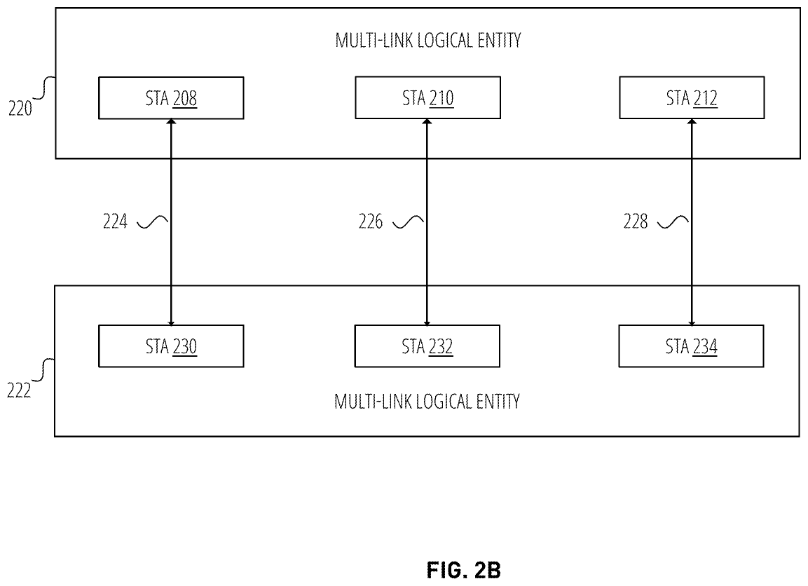

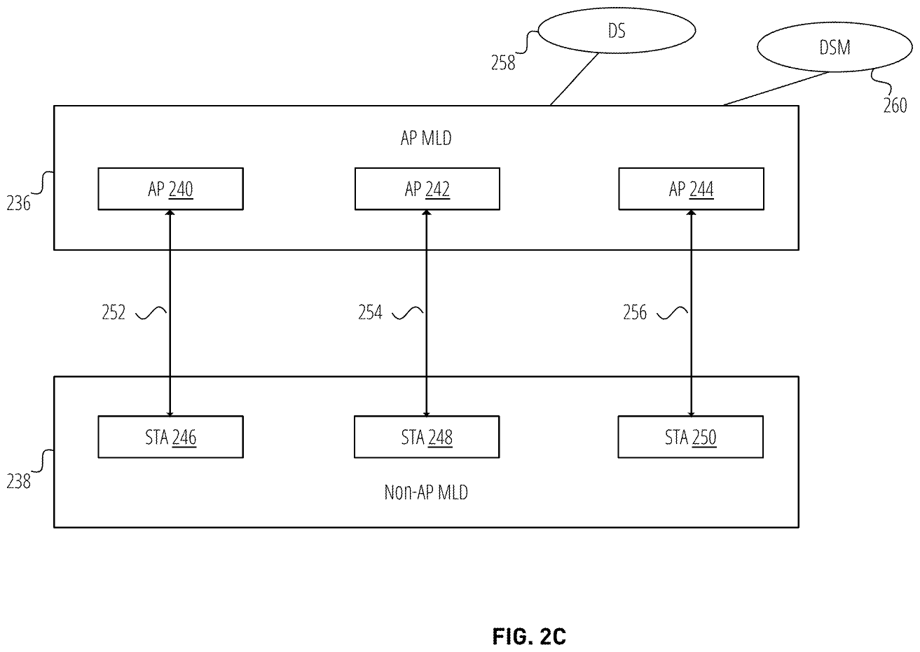

FIG. 2A is a network diagram illustrating an example network environment of multi-link operation, according to some aspects of the present technology. Wireless network 200 may include one or more STAs 204 (includes example devices 208, 210, and 212) and one or more APs 202, which may communicate in accordance with IEEE 802.11 communication standards. STAs 204 and APs 202 may be the same as STAs 104 and AP 102 of FIG. 1, respectively.

One or more STAs 204 and/or APs 202 may be operable by one or more user(s) 206.

STAs 204 and/or APs 202 may also include mesh stations in, for example, a mesh network, in accordance with one or more IEEE 802.11 standards and/or 3GPP standards.

Any of STAs 204 and APs 202 may be configured to communicate with each other via one or more communications networks 214 and/or networks 216, which may be the same as WLAN 100. STAs 204 may also communicate peer-to-peer or directly with each other with or without APs 202. Any of the communications networks 214 and/or networks 216 may include, but are not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 214 and/or networks 214 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 214 and/or networks 216 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of STAs 204 and APs 202 may be configured to perform directional transmission and/or directional reception in conjunction with wirelessly communicating in a wireless network. Any of STAs 204 and APs 202 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of STAs 204 and APs 202 may be configured to perform any given directional transmission towards one or more defined transmit sectors. Any of STAs 204 and APs 202 may be configured to perform any given directional reception from one or more defined receive sectors.

Multiple Input—Multiple Output (MIMO) beamforming in a wireless network may be accomplished using RF beamforming and/or digital beamforming. In some embodiments, in performing a given MIMO transmission, STAs 204 and/or APs 202 may be configured to use all or a subset of its one or more communications antennas to perform MIMO beamforming.

Any of STAs 204 and APs 202 may include any suitable radio and/or transceiver for transmitting and/or receiving radio frequency (RF) signals in the bandwidth and/or channels corresponding to the communications protocols utilized by any of STAs 204 and APs 202 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In example embodiments, the radio component, in cooperation with the communications antennas, may be configured to communicate via 2.4 GHz channels (e.g., 802.11b, 802.11g, 802.11n, 802.11ax), 5 GHz channels (e.g., 802.11n, 802.11ac, 802.11ax), or 60 GHZ channels (e.g., 802.11ad, 802.11ay). 800 MHz channels (e.g., 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g., IEEE 802.11af, IEEE 802.22), white band frequency (e.g., white spaces), or other packetized radio communications.

The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In some examples, and with reference to FIG. 1, APs 102 may facilitate multi-link operation 218 with one or more STAs 220.

In one example, multi-link operation 218 may have a single-radio non-access point MLD (non-AP MLD, e.g. an STA 204) listen to two or more channels simultaneously by (1) configuring a 2×2 Tx/Rx (or MxM Tx/Rx) to allocate a 1×1 resource on each channel/band (e.g., 5 GHz and 6 GHz), (2) add extra Rx modules, or (3) add wake-up receivers. An AP MLD then transmits on any idle channel a control frame (e.g., request to send (RTS) or multi-user (MU) RTS) before either a single data frame or a group of data frames within a single transmit opportunity (TXOP) to indicate that frames will be transmitted on that channel. The non-AP MLD responds back with a control frame (e.g., clear to send (CTS)). The single-radio non-AP MLD configures its radio back to 2×2 Tx/Rx module on the channel it received the control frame from the AP MLD and receives data. When using a wake-up receiver (802.11ba), the AP MLD transmits a wake-up packet. This also could be extended to other architectures with different antenna configurations. As example, a device with 3×3, when in that case a 2×2 resource on one channel and a 1×1 on another channel.

In one example, a multi-link operation 218 may enable a single-radio non-AP MLD to achieve throughput enhancement and latency reduction in a busy network without needing to implement a concurrent dual-radio, thus significantly reducing device cost.

FIG. 2B depicts an illustrative schematic diagram for multi-link operation between two logical entities, in accordance with one or more example embodiments of the present technology.

Referring to FIG. 2B, there are shown two multi-link logical entities 220 and 222 that can set up communication links 224, 226, and 228 with each other. A multi-link logical entity 220 or 222 may be a logical entity that contains one or more STAs such as STAs 204. The logical entity has one MAC data service interface and primitives to the logical link control (LLC) and a single address associated with the interface, which can be used to communicate on the distribution system medium (DSM). It should be noted that a Multi-link logical entity allows STAs within the multi-link logical entity to have the same MAC address. It should also be noted that the exact name can be changed.

In this example of FIG. 2B, multi-link logical entity 220 and multi-link logical entity 222 may be two separate physical devices, where each one comprises a number of virtual or logical devices. For example, multi-link logical entity 220 may comprise three STAs such as STAs 208, 210, and 212. Multi-link logical entity 222 may include another three STAs (e.g., STAs 230, 232, and 234). In one example, STA 208 may communicate with STA 230 over link 224, STA 210 may communicate with STA 232 over link 226, and STA 212 may communicate with STA 234 over link 228.

FIG. 2C depicts an illustrative schematic diagram for multi-link operation between APs with logical entities and a non-AP with logical entities, according to some aspects of the present technology.

Referring to FIG. 2C, two multi-link logical entities 236 and 238 are shown. AP logical entity 236 may include physical and/or logical APs 240, 242, and 244 operating in different frequency bands (e.g., 2.4 GHz, 5 GHz, and 6 GHz). APs 240, 242, and 244 can be the same as AP 102 and/or any one of APs 202 described above. Non-AP logical entity 238 may include STAs STA 246, STA 248, and STA 250, which may be the same as or similar to STAs 208, 210, 212, 230, 232, and/or 234.

AP 240 may communicate with STA 246 via link 252. AP 242 may communicate with STA 248 via link 254. AP 244 may communicate with STA 250 via link 256.

Multi-link AP logical entity 236 is shown in FIG. 2C to have access to a distribution system (DS) 258, which is a system used to interconnect a set of BSSs to create an extended service set (ESS). The multi-link AP logical entity 236 is also shown in FIG. 2C to have access a distribution system medium (DSM) 260, which is the medium used by a DS for BSS interconnections. Simply put, DS and DSM allow the AP to communicate with different BSSs.

It should be understood that although the example shows three logical entities within the multi-link AP logical entity and the three logical entities within the multi-link non-AP logical entity, this is merely for illustration purposes and that other numbers of logical entities with each of the multi-link AP and non-AP logical entities may be envisioned.

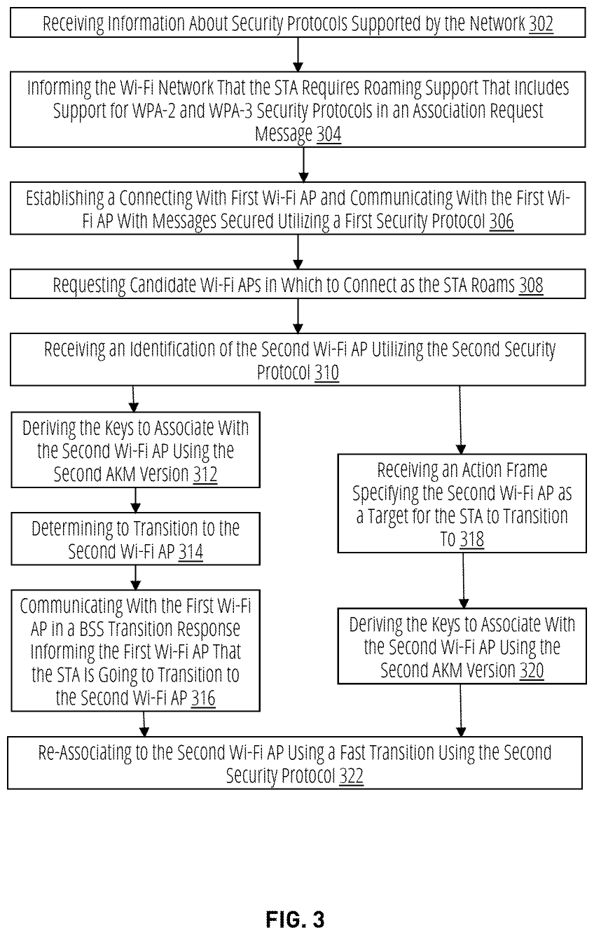

FIG. 3 illustrates an example routine for facilitating a fast transition for a STA roaming from a first Wi-Fi AP to a second Wi-Fi AP where the Wi-Fi APs utilize different security protocols in accordance with some aspects of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The disclosed technology addresses the need in the art for efficient re-association of a STA from a first Wi-Fi AP to a second Wi-Fi AP where the respective Wi-Fi APs utilize different security protocols. For example, Wi-Fi APs using Wi-Fi 5/6 technology use WPA-2 while Wi-Fi APs of newer generations using Wi-Fi 7/8 technology use WPA-3 security protocols. WPA-2 and WPA-3 use different MKA versions and cipher suites. The present technology provides for the efficient re-association of the STA to the second Wi-Fi AP that uses different keys and key exchange mechanisms than the first Wi-Fi AP without requiring initiation of a key exchange protocol. The disclosed technology also works whether the STA is roaming from a Wi-Fi AP using WPA-2 to a Wi-Fi AP using WPA-3, or in the inverse direction where the STA is roaming from a Wi-Fi AP using WPA-3 to a Wi-Fi AP using WPA-2.

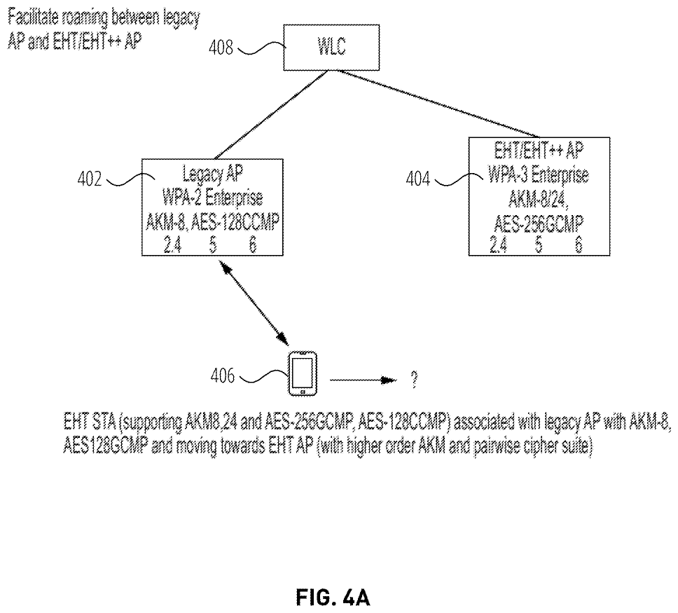

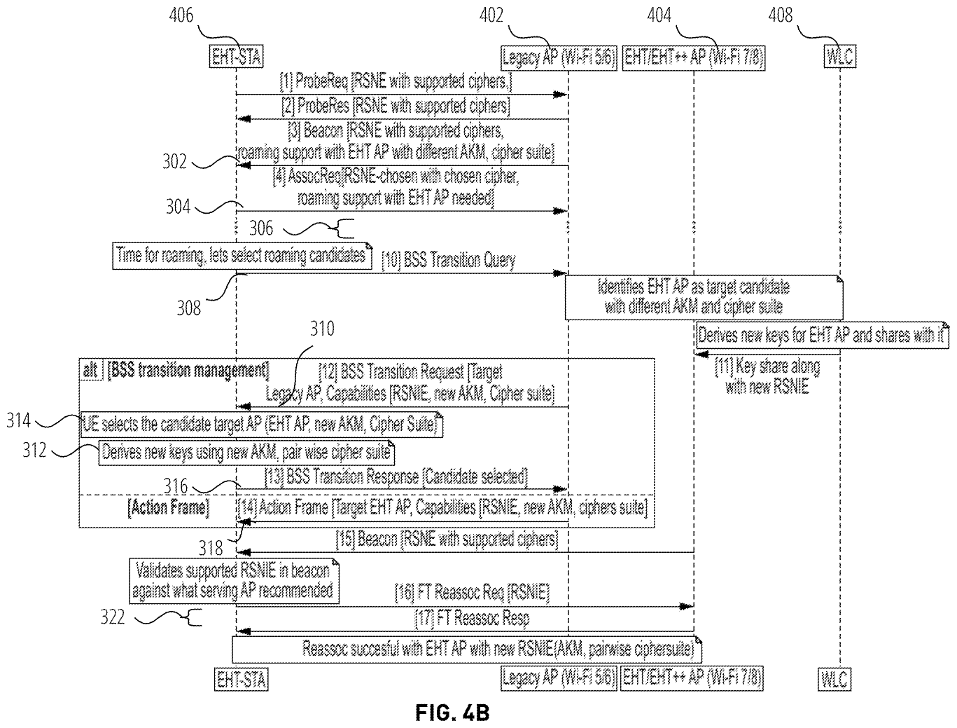

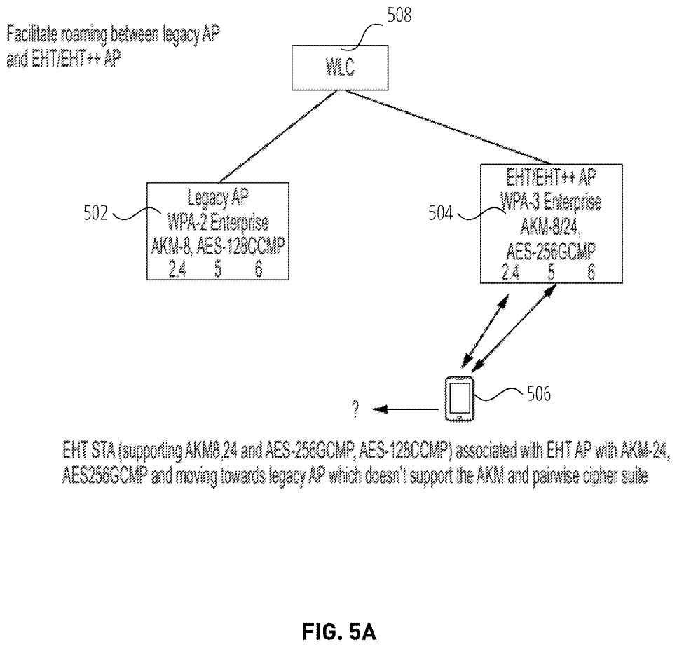

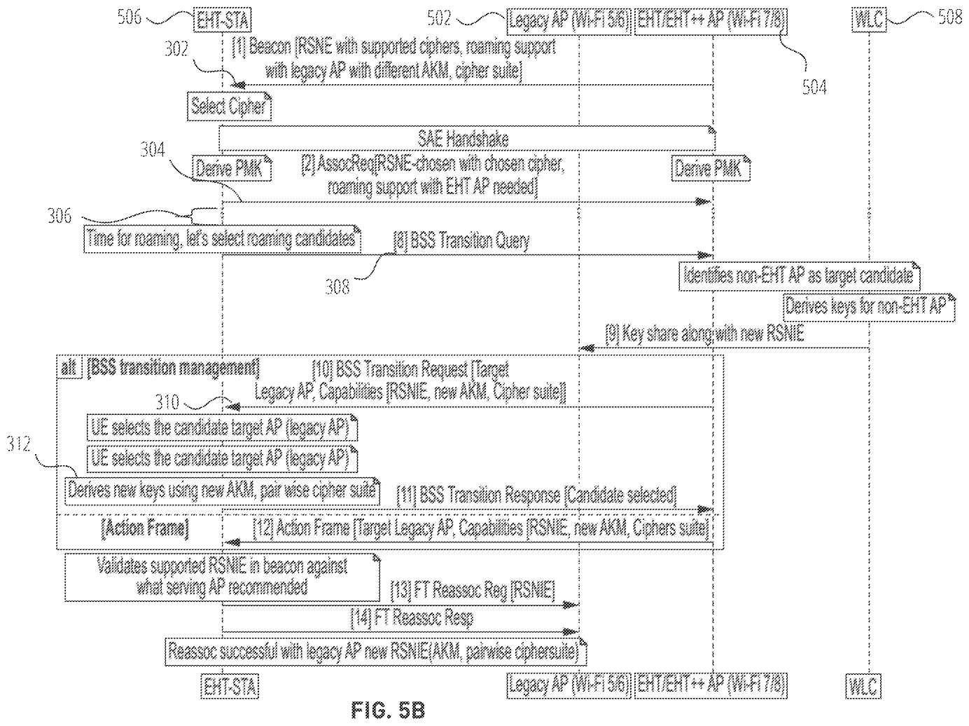

FIG. 3 will be discussed in the context of FIG. 4A and FIG. 4B, which illustrate a STA roaming from a Wi-Fi AP using WPA-2 to a Wi-Fi AP using WPA-3, and FIG. 5A and FIG. 5B, which illustrate a STA roaming from a Wi-Fi AP using WPA-3 to a Wi-Fi AP using WPA-2. The actions occurring in FIG. 3 are generic between the embodiments illustrated in FIG. 4A and FIG. 4B and FIG. 5A and FIG. 5B, however, some details are different between the embodiments, and these are highlighted herein.

Throughout the present disclosure, reference is made to an extremely high throughput (EHT) STA. This designates that the STA is capable of communications with Wi-Fi 7/8 Access Points which are capable of communication throughput at speeds of 30 Gbps and potentially greater in later technologies. It is not strictly required that a STA be capable of extremely high throughput (EHT) to take advantage of the present technology, though most commonly the STA will be capable of extremely high throughput (EHT) if it is capable of connecting with a Wi-Fi 7/8 access point. Therefore reference to extremely high throughput (EHT) capable STAs is illustrative only, and not a requirement.

FIG. 4B begins with an STA 406 connecting to first Wi-Fi AP 402. In FIG. 4A and FIG. 4B the first Wi-Fi AP 402 is a Wi-Fi 5/6 AP that utilizes the WPA-2 security protocol. As illustrated in FIG. 4B, in Wi-Fi 5/6, the STA 406 performs a probe request advertising the key management methods and cipher suites supported by the STA 406. When the STA 406 wants to join a Wi-Fi network, it sends out Probe Request frames to discover available access points (APs) in the vicinity. These Probe Request frames contain information about the client device and its capabilities. In the context of security, the client device may include an RSNE element in the Probe Request frame to indicate its support for a specific security protocol. The RSNE element carries information related to the security capabilities such as the security protocol, encryption algorithms, key management methods, and other security-related parameters supported by the STA 406. These steps do not occur in FIG. 5B.

According to some examples, the method includes receiving information about security protocols supported by the network at block 302. For example, in both FIG. 4B and FIG. 5B, the STA 406/STA 506 may receive information about security protocols supported by the network. In this communication, the first Wi-Fi AP 402/first Wi-Fi AP 504 learns of security protocols available to the Wi-Fi AP in an extended service set (ESS). In other words, the STA learns that the network supports multiple Wi-Fi technologies and associated security protocols.

According to some examples, the method includes informing the Wi-Fi network that the STA requires roaming support that includes both Wi-Fi APs that support WPA-2 and WPA-3 security protocols in an association request at block 304. For example, in both FIG. 4B and FIG. 5B, the STA 406/STA 506 may inform the wireless controller 408/wireless controller 508 through a communication with the first Wi-Fi AP 402/first Wi-Fi AP 504 that the STA requires roaming support that includes both Wi-Fi APs that support WPA-2 and WPA-3 security protocols in a basic service set (BSS) query.

According to some examples, the method includes establishing a connection with the first Wi-Fi AP and communicating with the first Wi-Fi AP with messages secured utilizing a first security protocol at block 306. For example, in both FIG. 4B and FIG. 5B, the STA 406/STA 506 may establish a connection with the first Wi-Fi AP to communicate with the first Wi-Fi AP with messages secured utilizing a first security protocol. Various steps take place that are not shown in FIG. 4B and FIG. 5B in furtherance of establishing the connection. These steps can be different in the Wi-Fi 5/6 and Wi-Fi 7/8 standards. For example, in Wi-Fi 5/6 which utilizes WPA-2, the STA and the AP perform a 4-way handshake to exchange and derive security keys as part of association and key management (AKM) 8.

After the STA determines that it is ready to roam to another Wi-Fi AP, it can initiate steps to roam. According to some examples, the method includes requesting candidate Wi-Fi APs in which to connect as the STA roams by making a BSS Transition Query at block 308. For example, in both FIG. 4B and FIG. 5B, the STA 406/STA 506 may request candidate Wi-Fi APs in which to connect as the STA roams.

The wireless controller 408/wireless controller 508 can determine that the STA 406/STA 506 supports both WPA-2 and WPA-3 security protocols (as was communicated at block 304). Accordingly, the wireless controller 408/wireless controller 508 can identify candidate APs in the extended service set (ESS) that support the technologies for which the STA is capable of connecting and can share the BSS information for each of the candidate APs along with the association and key management (AKM) version and cipher suites supported by the identified candidate APs.

According to some examples, the method includes receiving an identification of the second Wi-Fi AP utilizing the second security protocol at block 310. For example, in both FIG. 4B and FIG. 5B, the STA 406/STA 506 may receive an identification of the second Wi-Fi AP utilizing the second security protocol.

The second security protocol is different than the first security protocol. The first security protocol includes a first AKM version and first cipher suite and the second security protocol utilizes the second AKM version and second cipher suite.

More specifically, in the embodiments illustrated in FIG. 4A and FIG. 4B the first security protocol is a WPA-2 and the first AKM version and first cipher suite comply with the WPA-2 security protocol. WPA-2 supports AKM versions 8, and AES-128CCMP encryption. And the second security protocol is a WPA-3 and the second AKM version and second cipher suite comply with the WPA-3 security protocol. WPA-3 supports AKM versions 8 and 24 and AES-256GCMP encryption.

In the embodiments illustrated in FIG. 5A and FIG. 5B the first security protocol is a WPA-3 and the first AKM version and first cipher suite comply with the WPA-3 security protocol. And the second security protocol is a WPA-2 and the second AKM version and second cipher suite complies with the WPA-2 security protocol.

In some embodiments, the STA can receive information about a plurality of Wi-Fi APs including the second Wi-Fi AP. In such embodiments, the STA or the WLC can decide which of the plurality of Wi-Fi APs will be selected as the second Wi-Fi AP.

The present technology contemplates at least two embodiments for the determination to transition to the second Wi-Fi AP. The embodiments are not mutually exclusive, though they might be redundant in some effects.

In some embodiments, the method includes deriving the keys to associate with the second Wi-Fi AP using the second AKM version at block 312. For example, in both FIG. 4B and FIG. 5B, the STA 406/STA 506 may derive the keys to associate with the second Wi-Fi AP using the second AKM version. The method further includes determining to transition to the second Wi-Fi AP at block 314. For example, in both FIG. 4B and FIG. 5B, the STA 406/STA 506 may determine to transition to the second Wi-Fi AP. The method further includes communicating with the first Wi-Fi AP in a BSS transition response informing the first Wi-Fi AP that the STA is going to transition to the second Wi-Fi AP at block 316. For example, in both FIG. 4B and FIG. 5B, the STA 406/STA 506 may communicate with the first Wi-Fi AP in a BSS transition response informing the first Wi-Fi AP that the STA is going to transition to the second Wi-Fi AP.

In some embodiments, the method includes receiving an action frame specifying the second Wi-Fi AP as a target for the STA to transition at block 318. For example, in both FIG. 4B and FIG. 5B, the STA 406/STA 506 may receive an action frame from the first Wi-Fi AP 402/first Wi-Fi AP 504 specifying the second Wi-Fi AP as a target for which the STA to transition. The action frame is modified to inform the STA to prepare the keys (Pairwise Master Key (PMK), Pairwise Transient Key (PTK)) needed to establish a secure connection with the second Wi-Fi AP 404/second Wi-Fi AP 502. This exchange may require negotiating the association and key management (AKM) and cipher suite supported by the second Wi-Fi AP 404/second Wi-Fi AP 502.

According to some examples, the method includes re-associating to the second Wi-Fi AP using a fast transition using the second security protocol at block 322. For example, in both FIG. 4B and FIG. 5B, the STA 406/STA 506 may re-associate to the second Wi-Fi AP using a fast transition using the second security protocol. Since the STA 406/STA 506 has already derived the new keys and is prepared to handle communications using the correct cipher suite, the STA 406/STA 506 is able to support a fast transition within the extended service set (ESS).

Fast Transition (FT) is a mechanism within Wi-Fi networks that enables fast and seamless roaming by a STA between access points (APs) without the need for reauthentication.

As illustrated in FIG. 4B and FIG. 5B, the STA 406/STA 506 sends a Fast Transition Request (FT Reassoc Request) frame to the second Wi-Fi AP 404/second Wi-Fi AP 502 indicating its intention to roam. The FT Request includes information such as the client's identity and the Pairwise Master Key (PMK) Identifier (PMKID). The second Wi-Fi AP 404/second Wi-Fi AP 502, having previously cached the Pairwise Master Key (PMK), can quickly establish a secure connection with the client using the stored Pairwise Master Key (PMK). The second Wi-Fi AP 404/second Wi-Fi AP 502 responds to the FT Request with a Fast Transition Response (FT Reassoc Response) frame. This frame contains the information necessary for the STA 406/STA 506 and second Wi-Fi AP 404/second Wi-Fi AP 502 to verify the authenticity of the connection and session keys (derived at block 312).

Accordingly, the present technology provides for efficient re-association of a STA from a first Wi-Fi AP to a second Wi-Fi AP where the respective Wi-Fi APs utilize different security protocols. Since the association and key management (AKM) protocols are different and the cipher suites between generations of Wi-Fi technology, a STA normally would not be able to take advantage of the fast transition process. However, since the present technology allows the STA to derive the security keys in advance, the STA can perform the fast transition and efficiently roam to the Wi-Fi AP that utilizes a different association and key management (AKM) version.

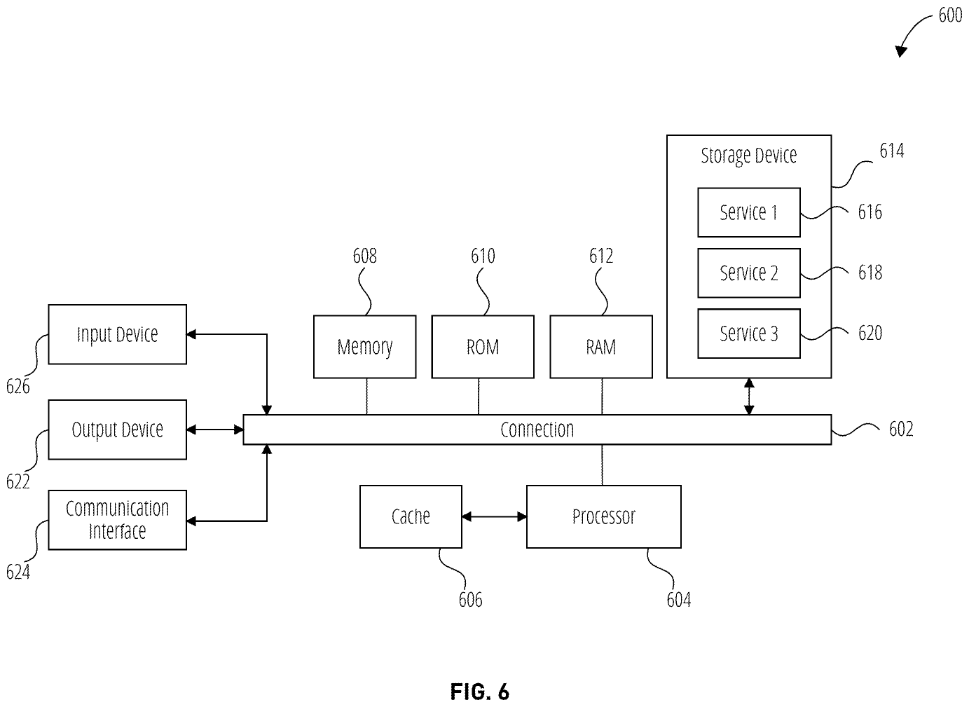

FIG. 6 shows an example of computing system 600, which can be for example any computing device making up an AP or STA or WLC, or any component thereof in which the components of the system are in communication with each other using connection 602. Connection 602 can be a physical connection via a bus, or a direct connection into processor 604, such as in a chipset architecture. Connection 602 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 600 includes at least one processing unit (CPU or processor) 604 and connection 602 that couples various system components including system memory 608, such as read-only memory (ROM) 610 and random access memory (RAM) 612 to processor 604. Computing system 600 can include a cache of high-speed memory 606 connected directly with, in close proximity to, or integrated as part of processor 604.

Processor 604 can include any general purpose processor and a hardware service or software service, such as services 616, 618, and 620 stored in storage device 614, configured to control processor 604 as well as a special-purpose processor where software instructions are incorporated into the actual processor design. Processor 604 may essentially be a completely self-contained computing system, containing multiple cores or processors, a bus, memory controller, cache, etc. A multi-core processor may be symmetric or asymmetric.

To enable user interaction, computing system 600 includes an input device 626, which can represent any number of input mechanisms, such as a microphone for speech, a touch-sensitive screen for gesture or graphical input, keyboard, mouse, motion input, speech, etc. Computing system 600 can also include output device 622, which can be one or more of a number of output mechanisms known to those of skill in the art. In some instances, multimodal systems can enable a user to provide multiple types of input/output to communicate with computing system 600. Computing system 600 can include communication interface 624, which can generally govern and manage the user input and system output. There is no restriction on operating on any particular hardware arrangement, and therefore the basic features here may easily be substituted for improved hardware or firmware arrangements as they are developed.

Storage device 614 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 614 can include software services, servers, services, etc., that when the code that defines such software is executed by the processor 604, it causes the system to perform a function. In some embodiments, a hardware service that performs a particular function can include the software component stored in a computer-readable medium in connection with the necessary hardware components, such as processor 604, connection 602, output device 622, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Some aspects of the present technology include:

Aspect 1. A method comprising: communicating with the first Wi-Fi AP with messages secured utilizing a first security protocol; requesting candidate Wi-Fi APs in which to connect as the STA roams; where the second security protocol is different than the first security protocol; and re-associating to the second Wi-Fi AP using a fast transition using aspects of the second security protocol.

Aspect 2. The method of Aspect 1, further comprising: informing the Wi-Fi network that the STA requires roaming support that includes support for WPA-2 and WPA-3 security protocols in an association request message.

Aspect 3. The method of any of Aspects 1 to 2, further comprising: prior to a handshake with the first Wi-Fi AP, sharing information about security protocols supported by the STA with the network; and establishing a connection with first Wi-Fi AP.

Aspect 4. The method of any of Aspects 1 to 3, wherein the first security protocol includes a first AKM version and a first cipher suite and the second security protocol utilizes the second AKM version and a second cipher suite.

Aspect 5. The method of any of Aspects 1 to 4, further comprising: prior to the re-associating to the second Wi-Fi AP, deriving the keys to associate with the second Wi-Fi AP using the second AKM version.

Aspect 6. The method of any of Aspects 1 to 5, further comprising: determining to transition to the second Wi-Fi AP; communicating with the first Wi-Fi AP in a BSS Transition response informing the first Wi-Fi AP that the STA is going to transition to the second Wi-Fi AP.

Aspect 7. The method of any of Aspects 1 to 6, further comprising: receiving an action frame specifying the second Wi-Fi AP as a target to which to transition.

Aspect 8. The method of any of Aspects 1 to 7, wherein the receiving the identification of the second Wi-Fi AP utilizing the second security protocol includes receiving a plurality of Wi-Fi APs including the second Wi-Fi AP.

What is claimed is:

1. A method comprising:
communicating, by an STA, with a first Wi-Fi AP with messages secured utilizing a first security protocol;
requesting candidate Wi-Fi APs in which to connect as a STA roams;
receiving an identification of a second Wi-Fi AP utilizing a second security protocol, where the second security protocol is different than the first security protocol; and
re-associating to the second Wi-Fi AP using a fast transition using aspects of the second security protocol.

2. The method of claim 1, further comprising:
informing entities within a Wi-Fi network that the STA requires roaming support that includes support for WPA-2 and WPA-3 security protocols in an association request message.

3. The method of claim 1, further comprising:
prior to a handshake with the first Wi-Fi AP, sharing information about security protocols supported by the STA within a Wi-Fi network; and
establishing a connection with the first Wi-Fi AP.

4. The method of claim 1, wherein the first security protocol includes a first AKM version and a first cipher suite and the second security protocol utilizes a second AKM version and a second cipher suite.

5. The method of claim 1, further comprising:
prior to the re-associating to the second Wi-Fi AP, deriving keys to associate with the second Wi-Fi AP using a second AKM version.

6. The method of claim 1, further comprising:
determining to transition to the second Wi-Fi AP;
communicating with the first Wi-Fi AP in a BSS Transition response informing the first Wi-Fi AP that the STA is going to transition to the second Wi-Fi AP.

7. The method of claim 1, further comprising:
receiving an action frame specifying the second Wi-Fi AP as a target to which to transition.

8. The method of claim 1, wherein the receiving the identification of the second Wi-Fi AP utilizing the second security protocol includes receiving a plurality of Wi-Fi APs including the second Wi-Fi AP.

9. A computing apparatus comprising:
a processor; and
a memory storing instructions that, when executed by the processor, configure the apparatus to:
communicate, by an STA, with a first Wi-Fi AP with messages secured utilizing a first security protocol;
request candidate Wi-Fi APs in which to connect as a STA roams;
receive an identification of a second Wi-Fi AP utilizing a second security protocol, where the second security protocol is different than the first security protocol; and
re-associate to the second Wi-Fi AP using a fast transition using aspects of the second security protocol.

10. The computing apparatus of claim 9, wherein the instructions further configure the apparatus to:
inform entities within a Wi-Fi network that the STA requires roaming support that includes support for WPA-2 and WPA-3 security protocols in an association request message.

11. The computing apparatus of claim 9, wherein the instructions further configure the apparatus to:
prior to a handshake with the first Wi-Fi AP, share information about security protocols supported by the STA within a Wi-Fi network; and
establish a connection with the first Wi-Fi AP.

12. The computing apparatus of claim 9, wherein the first security protocol includes a first AKM version and a first cipher suite and the second security protocol utilizes a second AKM version and a second cipher suite.

13. The computing apparatus of claim 9, wherein the instructions further configure the apparatus to:
prior to the re-associating to the second Wi-Fi AP, derive keys to associate with the second Wi-Fi AP using a second AKM version.

14. The computing apparatus of claim 9, wherein the instructions further configure the apparatus to:
determine to transition to the second Wi-Fi AP;
communicate with the first Wi-Fi AP in a BSS Transition response informing the first Wi-Fi AP that the STA is going to transition to the second Wi-Fi AP.

15. The computing apparatus of claim 9, wherein the instructions further configure the apparatus to:
receive an action frame specifying the second Wi-Fi AP as a target to which to transition.

16. A non-transitory computer-readable storage medium, the computer-readable storage medium including instructions that when executed by a computer, cause the computer to:
communicate, by an STA, with a first Wi-Fi AP with messages secured utilizing a first security protocol;
request candidate Wi-Fi APs in which to connect as a STA roams;
receive an identification of a second Wi-Fi AP utilizing a second security protocol, where the second security protocol is different than the first security protocol; and
re-associate to the second Wi-Fi AP using a fast transition using aspects of the second security protocol.

17. The computer-readable storage medium of claim 16, wherein the instructions further configure the computer to:
inform entities within a Wi-Fi network that the STA requires roaming support that includes support for WPA-2 and WPA-3 security protocols in an association request message.

18. The computer-readable storage medium of claim 16, wherein the instructions further configure the computer to:
prior to the re-associating to the second Wi-Fi AP, derive keys to associate with the second Wi-Fi AP using a second AKM version.

19. The computer-readable storage medium of claim 16, wherein the instructions further configure the computer to:
determine to transition to the second Wi-Fi AP;
communicate with the first Wi-Fi AP in a BSS Transition response informing the first Wi-Fi AP that the STA is going to transition to the second Wi-Fi AP.

20. The computer-readable storage medium of claim 16, wherein the instructions further configure the computer to:
receive an action frame specifying the second Wi-Fi AP as a target to which to transition.
